(19) United States
(12) Patent Application Publication
(10) Pub. No.: US 2024/0238144 A1
(43) Pub. Date: Jul. 18, 2024

(54) VERTICAL RHYME MACHINE

(71) Applicant: KUANG YU METAL WORKING CO., LTD., Changhua County (TW)

(72) Inventors: Wen-Hsu HSIEH, Changhua County (TW); Po-Chien HSIEH, Changhua County (TW)

(21) Appl. No.: 18/415,605

(22) Filed: Jan. 17, 2024

(30) Foreign Application Priority Data
Jan. 18, 2023 (TW) 112102274

(51) Int. Cl. A61H 1/00; A61H 23/02

(52) U.S. Cl. CPC A61H 1/005; A61H 23/0263; A61H 2201/149; A61H 2201/1678; A61H 2203/0406

(57) ABSTRACT

A vertical rhyme machine includes a base, a first actuating mechanism, a top cover and a second actuating mechanism. The first actuating mechanism includes a first motor assembly, a first shaft assembly and two first linkage assemblies. The first motor assembly is disposed at the base. The first shaft assembly includes a first shaft body and two first eccentric linking elements. The two first eccentric linking elements are connected to two ends of the first shaft body, respectively. The second actuating mechanism includes a second motor assembly, a second shaft assembly and two second linkage assemblies. The second motor assembly disposed at the base. The second shaft assembly includes a second shaft body and two second eccentric linking elements. The second shaft body is disposed at the base. The two second eccentric linking elements are connected to two ends of the second shaft body, respectively.

### RELATED APPLICATIONS

This application claims priority to Taiwan Application Serial Number 112102274, filed Jan. 18, 2023, which is herein incorporated by reference.

### BACKGROUND

### Technical Field

The present disclosure relates to a fitness equipment. More particularly, the present disclosure relates to a vertical rhyme machine with a vertical oscillation.

### Description of Related Art

In a conventional vertical rhyme machine, a driving mechanism is configured on a base, and the driving mechanism drives a transmission mechanism to do reciprocating motion to move a top cover in a vertical oscillation with single amplitude.

However, the vertical rhyme machine with a single amplitude can only move a human body in the oscillation with the single amplitude, and there is an improvement awaited. Therefore, in Taiwanese patent TWI714233B, a plurality of pivot connecting parts are disposed at the transmission mechanism in different positions, and a major platform is connected to an outer pivot connecting part and a minor platform is connected to an inner pivot connecting part, so that the same reciprocating motion can generate an oscillating amplitude of the major platform and another oscillating amplitude of the minor platform which are different from each other. However, by disposing a plurality of pivot connecting parts at the transmission mechanism, the stress of the transmission mechanism tends to be complicated and the transmission mechanism becomes easy to be broken down, so the manufacturing cost of the transmission mechanism increases to maintain the security.

In Taiwanese patent TWI747484B, a movable plate is disposed to connect a first transmission mechanism which is driven by a first driving mechanism, and a second transmission mechanism and a second driving mechanism with the same complicated structure as the first transmission mechanism and the first driving mechanism are disposed on the movable plate, so that the first transmission mechanism and the first driving mechanism can move the platform in the oscillation with a first amplitude, and the second transmission mechanism and the second driving mechanism can move the movable plate in the oscillation with a second amplitude to generate the different amplitudes. However, the configuration of the movable plate tends to increase manufacturing and assembling cost; the space usage of the increasing mechanism is large to increase the difficulty of maintenance.

Accordingly, for the above problems, how to provide a vertical rhyme machine oscillating in at least one amplitude, and how to simplify the structure and reduce the cost thereof, are still problems and pursued targets of practitioners.

### SUMMARY

According to one aspect of the present disclosure, a vertical rhyme machine includes a base, a first actuating mechanism, a top cover and a second actuating mechanism. The first actuating mechanism includes a first motor assembly, a first shaft assembly and two first linkage assemblies. The first motor assembly is disposed at the base. The first shaft assembly is driven by the first motor assembly to rotate, and includes a first shaft body and two first eccentric linking elements. The two first eccentric linking elements are connected to two ends of the first shaft body, respectively. The two first linkage assemblies are connected to the two first eccentric linking elements, respectively. The top cover is moved by the two first linkage assemblies. The second actuating mechanism includes a second motor assembly, a second shaft assembly and two second linkage assemblies. The second motor assembly is disposed at the base. The second shaft assembly is driven by the second motor assembly to rotate, and includes a second shaft body and two second eccentric linking elements. The second shaft body is disposed at the base. The two second eccentric linking elements are connected to two ends of the second shaft body, respectively. The two second linkage assemblies are connected to the two second eccentric linking elements, respectively, and the two second linkage assemblies are connected to the first shaft assembly of the first actuating mechanism. The first motor assembly drives the two first linkage assemblies to move the top cover in a first oscillation, the second motor assembly drives the two second linkage assemblies and the first shaft assembly is linked to move the two first linkage assemblies, so as to move the top cover in a second oscillation, and an amplitude of the first oscillation is different from an amplitude of the second oscillation.

According to one aspect of the present disclosure, a vertical rhyme machine includes a base, at least one first actuating mechanism, a top cover and a second actuating mechanism. The at least one first actuating mechanism includes a first motor assembly, a first shaft assembly and two first waving rods. The first motor assembly is disposed at the base. The first shaft assembly is driven by the first motor assembly to rotate, and includes a first shaft body and two first eccentric linking elements. The two first eccentric linking elements are connected to two ends of the first shaft body, respectively. The two first waving rods are connected to the two first eccentric linking elements, respectively. The top cover is moved by the two first waving rods of the at least one first actuating mechanism. The second actuating mechanism includes a second motor assembly, a second shaft assembly and two second linkage assemblies. The second motor assembly disposed at the base. The second shaft assembly is driven by the second motor assembly to rotate, and includes a second shaft body and two second eccentric linking elements. The second shaft body is disposed at the base. The two second eccentric linking elements are connected to two ends of the second shaft body, respectively. The two second linkage assemblies are connected to the two second eccentric linking elements, respectively, and the two second linkage assemblies are connected to the first shaft assembly of one of the at least one first actuating mechanism. The first motor assembly of the at least one first actuating mechanism drives the two first waving rods of the at least one first actuating mechanism to move the top cover in an oscillation, the second motor assembly drives the two second linkage assemblies to move the first shaft assembly of the one of the at least one first actuating mechanism, so as to move the top cover in the oscillation by the two first waving rods of the one of the at least one first actuating mechanism.

### BRIEF DESCRIPTION OF THE DRAWINGS

The present disclosure can be more fully understood by reading the following detailed description of the embodiment, with reference made to the accompanying drawings as follows:

FIG. 1 shows a three-dimensional schematic view of a vertical rhyme

machine according to one embodiment of the present disclosure.

FIG. 2 shows a schematic view of a top cover separating from a base of

the vertical rhyme machine according to the embodiment in FIG. 1.

FIG. 3 shows an exploded view of a first motor assembly, a first shaft assembly and the base of the vertical rhyme machine according to the embodiment in FIG. 1.

FIG. 4 shows an exploded view of two first linkage assemblies, two second linkage assemblies and the base of the vertical rhyme machine according to the embodiment in FIG. 1.

FIG. 5 shows an exploded view of a second motor assembly, one of two second linkage assemblies and the base of the vertical rhyme machine according to the embodiment in FIG. 1.

FIG. 6A shows a sided view of the vertical rhyme machine when the top

cover is at the lowest point during swinging the first linkage assemblies in a first oscillation state according to the embodiment in FIG. 1.

FIG. 6B shows a sided view of the vertical rhyme machine when the top cover is at the highest point during swinging the first linkage assemblies in the first oscillation state according to the embodiment in FIG. 1.

FIG. 7A shows a sided view of the vertical rhyme machine when the top cover is at the lowest point during swinging the second linkage assemblies in a second oscillation state according to the embodiment in FIG. 1.

FIG. 7B shows a sided view of the vertical rhyme machine when the top cover is at the highest point during swinging the second linkage assemblies in the second oscillation state according to the embodiment in FIG. 1.

### DETAILED DESCRIPTION

The embodiments will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements be represented by the same labels.

It will be understood that when an element (or device) is referred to as being “connected to” another element, it can be directly connected to the other element, or it can be indirectly connected to the other element, that is, intervening elements be present. In contrast, when an element is referred to as being “directly connected to” another element, there are no intervening elements present. In addition, the terms first, second, third, etc. are used herein to describe various elements or components, these elements or components should not be limited by these terms. Consequently, a first element or component discussed below could be termed a second element or component. Besides, a combination of these elements (unite or circuits) of the present closure is not a common combination in this art, so it cannot be predicted whether a relation of the combination hereof can be easily done by a person having skill in the art by these elements (units or circuits).

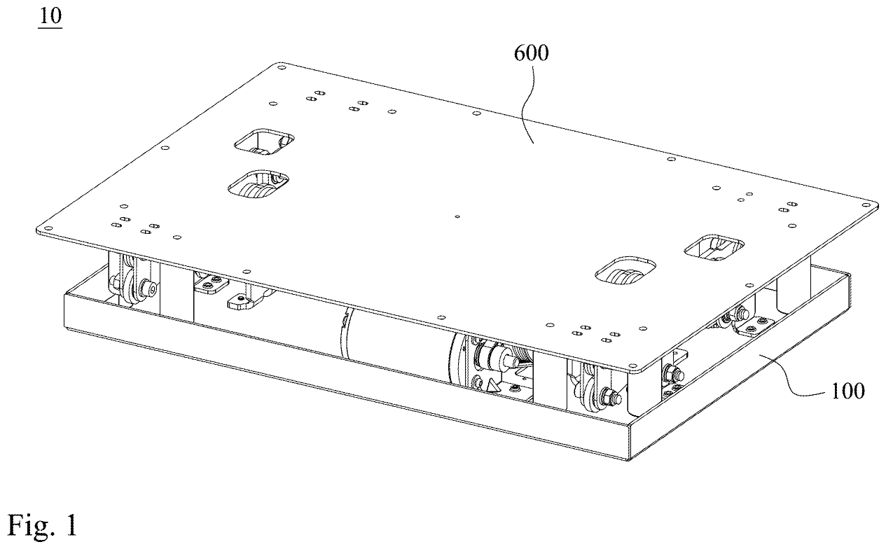

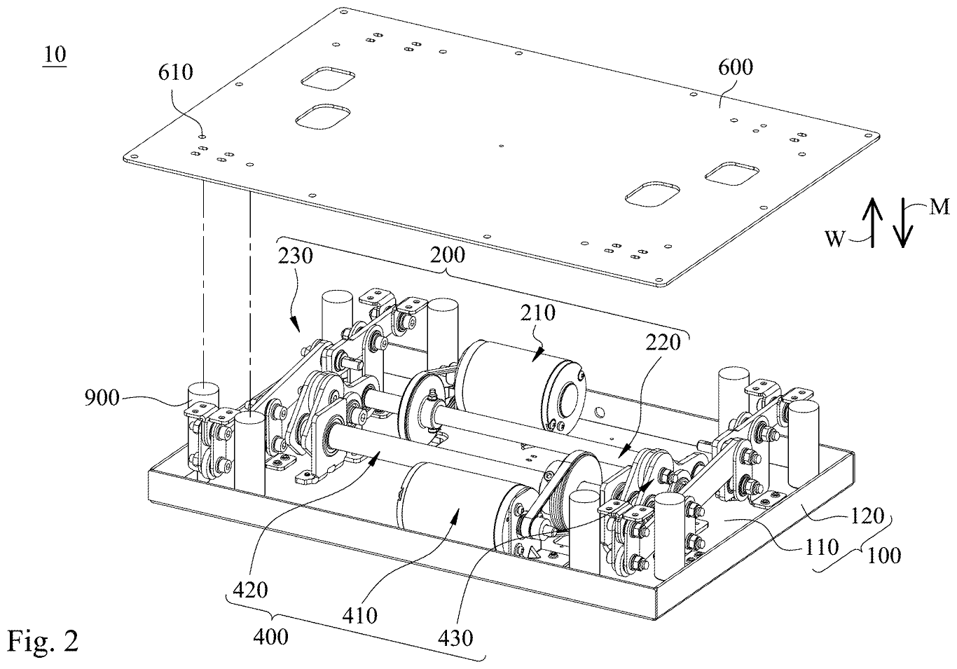

Please refer to FIGS. 1 and 2, FIG. 1 shows a three-dimensional schematic view of a vertical rhyme machine 10 according to one embodiment of the present disclosure, and FIG. 2 shows a schematic view of a top cover 600 separating from the base 100 of the vertical rhyme machine 10 according to the embodiment in FIG. 1. As shown in FIGS. 1 and 2, the vertical rhyme machine 10 includes a base 100, a first actuating mechanism 200, the top cover 600 and a second actuating mechanism 400.

The first actuating mechanism 200 includes a first motor assembly 210, a first shaft assembly 220 and two first linkage assemblies 230. The first shaft assembly 220 includes a first shaft body 221 and two first eccentric linking elements 222. The second actuating mechanism 400 includes a second motor assembly 410, a second shaft assembly 420 and two second linkage assemblies 430. The second shaft assembly 420 includes a second shaft body 421 and two second eccentric linking elements 422. The first motor assembly 210 is disposed at the base 100, the first shaft assembly 220 is driven by the first motor assembly 210 to rotate, the two first eccentric linking elements 222 are connected to two ends of the first shaft body 221, respectively, the two first linkage assemblies 230 are connected to the two first eccentric linking elements 222, respectively, and the top cover 600 is moved by the two first linkage assemblies 230. The second motor assembly 410 is disposed at the base 100, the two second eccentric linking elements 422 are connected to two ends of the second shaft body 421, respectively, the two second linkage assemblies 430 are connected to the two second eccentric linking elements 422, respectively, and the two second linkage assemblies 430 are connected to the first shaft assembly 220 of the first actuating mechanism 200. The first motor assembly 210 drives the two first linkage assemblies 230 to move the top cover 600 in a first oscillation, the second motor assembly 410 drives the two second linkage assemblies 430 and the first shaft assembly 220 is linked to move the two first linkage assemblies 230, so as to move the top cover 600 in a second oscillation, and an amplitude of the first oscillation is different from an amplitude of the second oscillation.

Therefore, the first shaft assembly 220 can be driven by the first motor assembly 210 to rotate and linked with the second motor assembly 410 to generate a vertical displacement; because the rotation and the displacement can occur separately or occur at the same time, the two first linkage assemblies 230 can swing alone or swing with the two second linkage assemblies 430 to move the top cover 600, and then the vertical rhyme machine 10 can move in the first oscillation, the second oscillation or the combination thereof. Moreover, configuring the elements of the second actuating mechanism 400 as many as the elements of the first actuating mechanism 200 can be prevented to reduce the quantities of elements and the cost.

As shown in FIG. 2, the base 100 can include a bottom plate 110 and a side wall 120 surrounding the bottom plate 110, and the side wall 120 is rectangular frame-shaped, so that an inner space is formed by the top cover 600, the bottom plate 110 and the side wall 120. In other embodiments, a top surface of the top cover can be substantially polygon-shaped for a user to step in, step out or stand on the vertical rhyme machine, and it is not limited to the figures.

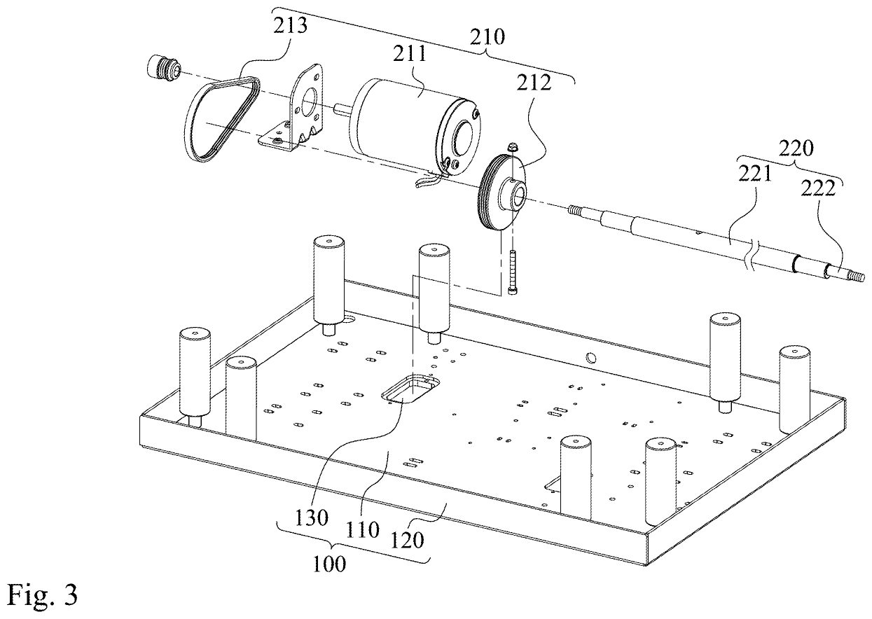

Please refer to FIG. 3 with reference of FIGS. 1 and 2, FIG. 3 shows an exploded view of a first motor assembly 210, a first shaft assembly 220 and the base 100 of the vertical rhyme machine 10 according to the embodiment in FIG. 1. It is worthy to be noticed that some elements are omitted for the clarity of the figures. As shown in FIG. 3, the first motor assembly 210 can include a first motor 211, a first driving roller 212 and a first belt 213. The first driving roller 212 is sleeved on the first shaft body 221, the first belt 213 connects the first driving roller 212 to an output shaft of the first motor 211, and the first motor 211 drives the first belt 213 to rotate the first shaft body 221. Furthermore, the base 100 can further include a recess portion 130 corresponding to the first driving roller 212. When the first shaft body 221 is driven by the second motor 411 to be lifted or lowered vertically, the recess portion 130 accommodates the first driving roller 212.

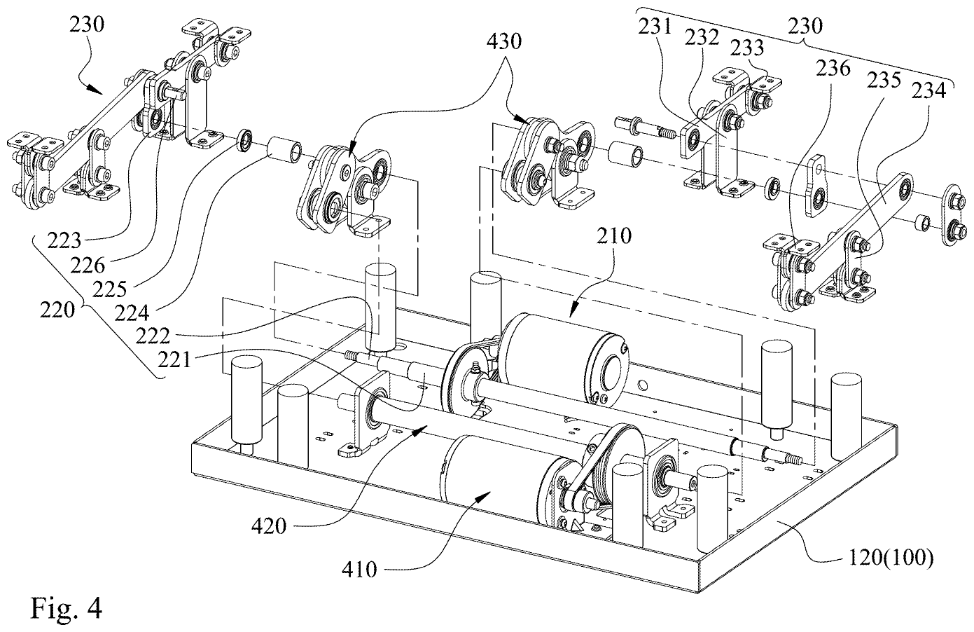

Please refer to FIG. 4 with the reference of FIGS. 2 and 3, FIG. 4 shows an exploded view of two first linkage assemblies 230, two second linkage assemblies 430 and the base 100 of the vertical rhyme machine 10 according to the embodiment in FIG. 1. The first shaft body 221 is long rod-shaped, the two first eccentric linking elements 222 can be integrally connected to the two ends of the first shaft body 221, respectively, and each of the two first eccentric linking elements 222 has an eccentric axial structure. That is, the first shaft body 221 connects the two first eccentric linking elements 222 to form an eccentric rod structure. The first shaft assembly 220 can further include two first driving elements 223, each of the two first driving elements 223 can be a panel, and each of the two first eccentric linking elements 222 can be inserted into a lower part of each of the two first driving elements 223, that is, the two first driving elements 223 can be connected to two ends of the eccentric axial structure, respectively. Furthermore, each of the two first linkage assemblies 230 and each of the two second linkage assemblies 430 can be pivotally connected to an upper part of each of the two first driving elements 223. The first shaft assembly 220 can further include two first bushings 224, two first linking rollers 225 and two first linking shafts 226. The two first bushings 224 are respectively sleeved on the two ends of the first shaft body 221 to protect the first shaft body 221, each of the two first linking rollers 225 is sleeved on each of the two first eccentric linking elements 222 to protect each of the two first eccentric linking elements 222, and each of the two first linking shafts 226 penetrates through each of the two first linkage assemblies 230, and each of the second linkage assemblies 430 and the upper part of each of the two first driving elements 223, so that the two second linkage assemblies 430 can link the first shaft assembly 220 to drive the two first linkage assemblies 230 to be lifted or lowered. In other embodiments, the first eccentric linking element can have an eccentric wheel structure and is sleeved on the first shaft body, that is, the first shaft body can exclude any eccentric element, and the eccentric motion can be generated by the first eccentric linking element. The first bushing, the first linking roller, the first linking shaft, etc. can be configured or omitted according to the requirements, but the present disclosure is not limited thereto.

As shown in FIGS. 2 to 4, each of the two first linkage assemblies 230 can include a first lower pivot element 232, a first upper pivot element 233 and a first waving rod 231. The first lower pivot element 232 is disposed at the base 100, the first upper pivot element 233 is disposed at the top cover 600, a first end of the first waving rod 231 is pivotally connected to the first shaft assembly 220, a second end of the first waving rod 231 is pivotally connected to the first upper pivot element 233, and the first waving rod 231 is pivotally connected to the first lower pivot element 232 to swing about the first lower pivot element 232 that is served as a pivot point. In details, each of the first lower pivot elements 232 can be formed by two panels, and each of the first waving rods 231 is sandwiched between the two panels of each of the first lower pivot elements 232. Each of the two panels of each of the first lower pivot elements 232 can be L-shaped and each of the two panels of each of the first lower pivot elements 232 includes a standing plate and a bottom portion, the standing plate is pivotally connected to the first waving rod 231, and the bottom portion is fixed at the base 100 and integrally connected to the standing plate; each of the first upper pivot elements 233 can be formed by two panels, and each of the first waving rods 231 is sandwiched between the two panels of each of the first upper pivot elements 233. Each of the two panels of each of the first upper pivot elements 233 can be L-shaped and each of the two panels of each of the first upper pivot elements 233 includes a standing plate and a top plate, the standing plate of each of the first upper pivot elements 233 is pivotally connected to the first waving rod 231, and the top plate of each of the first upper pivot elements 233 is fixed at the top cover 600 and integrally connected to the standing portion of each of the first upper pivot elements 233; each of the first waving rods 231 can be a panel structure, and a middle of each of the first waving rods 231 is pivotally connected to the first lower pivot element 232 so that each of the first waving rods 231 can substantially do lever movement relative to the base 100. In other embodiments, the first lower pivot element, the first upper pivot element, etc. can be configured according to the requirements, and a number of the panel of the first lower pivot element and a number of the panel of the first upper pivot element can be single, but the present disclosure is not limited thereto.

In another way, each of the two first linkage assemblies 230 can include a first bottom pivot element 235, a first top pivot element 236 and a first swinging rod 234. The first bottom pivot element 235 is pivotally connected to the base 100, the first top pivot element 236 is pivotally connected to the top cover 600, a first end of the first swinging rod 234 is pivotally connected to the first shaft assembly 220, a second end of the first swinging rod 234 is pivotally connected to the first top pivot element 236, and the first swinging rod 234 is pivotally connected to the first bottom pivot element 235 to swing about the first bottom pivot element 235 that is served as a pivot point. In details, each of the first bottom pivot elements 235 can include two swinging portions and two bottom fixing portions, the two swinging portions of each of the first bottom pivot elements 235 are pivotally connected to the first swinging rod 234, the first swinging rod 234 is sandwiched between the two swinging portions of each of the first bottom pivot elements 235, and each of the two bottom fixing portions of each of the first bottom pivot elements 235 is fixed at the base 100 and pivotally connected to each of the two swinging portions thereof; each of the first top pivot elements 236 can include two swinging portions and two top fixing portions, the two swinging portions of each of the first top pivot elements 236 are pivotally connected to the first swinging rod 234, the first swinging rod 234 is sandwiched between the two swinging portions of each of the first top pivot elements 236, and each of the two top fixing portions of each of the first top pivot elements 236 is fixed at the top cover 600 and pivotally connected to each of the two swinging portions thereof; a middle region of each of the first swinging rods 234 is pivotally connected to the first bottom pivot element 235, so that each of the first waving rods 231 can substantially do lever movement or swinging movement relative to the base 100. In other embodiments, the first lower pivot element, the first upper pivot element, etc. can be configured according to the requirements, but the present disclosure is not limited thereto.

Furthermore, the two first linkage assemblies 230 can be arranged systematically and close to two short sides of the side wall 120, respectively, and correspond to each other. The first waving rod 231 and the first swinging rod 234 of each of the two first linkage assemblies 230 can be pivotally connected to each of the two first linking shaft 226, and the first waving rod 231 and the first swinging rod 234 extend towards a direction far away from each other to correspond to two corners of each of the two short sides of the side wall 120, so as to move four corners of the top cover 600 to stabilize the oscillation. In another embodiment, in a perspective view from an outer side towards a short side of the side wall, an acute angle is formed between each of the first waving rods and each of the first swinging rods and each of the first waving rods and each of the first swinging rods extend towards the same direction, and the first shaft assembly is closer to one long side of the side wall compared with the first shaft assembly 220 of the embodiment in FIGS. 1 to 4, so as to increase a spacing between the first shaft assembly and the other long side of the side wall; in yet other embodiment, each of the two first linkage assemblies can include two first waving rods, and a number of the panel of each of the first upper pivot element and a number of the panel of the lower pivot element is single; in the other embodiments, each of the two first linkage assemblies can include two first swinging rods, a number of each of the swinging portion and a number of the top fixing portion of the first top pivot element can be single, a number of swinging portion and a number of the bottom fixing portion of the first bottom pivot element can be single, but the present disclosure is not limited thereto.

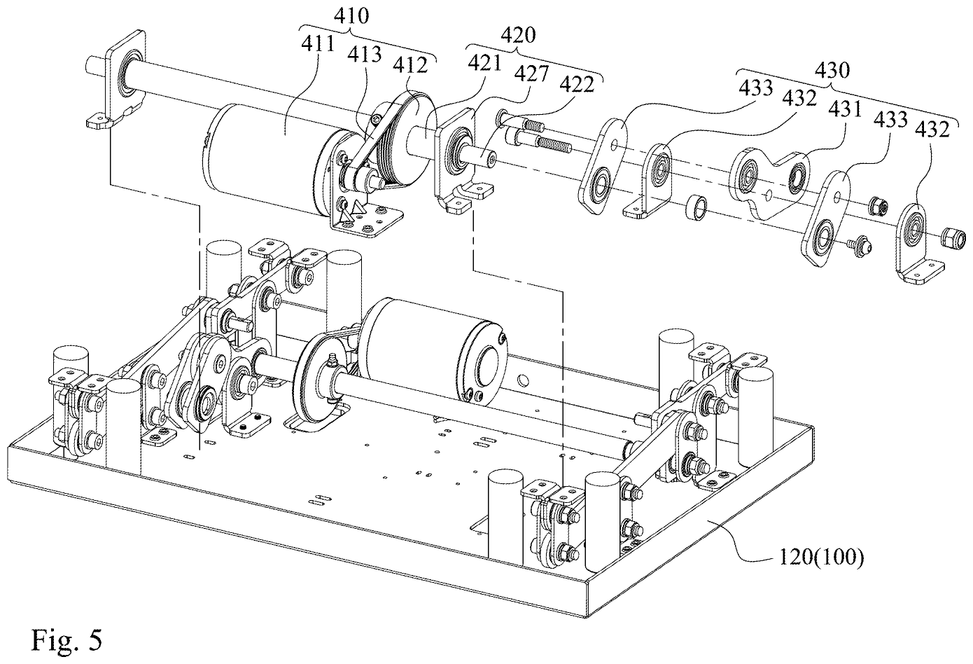

Please refer to FIG. 5 with the reference of FIGS. 2 to 4, FIG. 5 shows an exploded view of a second motor assembly 410, one of two second linkage assemblies 430 and the base 100 of the vertical rhyme machine 10 according to the embodiment in FIG. 1. As shown in FIG. 5, the second motor assembly 410 can include a second motor 411, a second driving roller 412 and a second belt 413. The second driving roller 412 is sleeved on the second shaft body 421, the second belt 413 connects the second driving roller 412 to an output shaft of the second motor 411, and the second motor 411 drives the second belt 413 to rotate the second shaft body 421. The elements and mechanism of the second motor 411 and the second shaft assembly 420 are similar with the elements and mechanism of the first motor 211 and the first shaft assembly 220, and the details are not described herein again. However, it is worthy to be mentioned that the second shaft assembly 420 can further include two second shaft bases 427 sleeved on the two ends of the second shaft body 421, each of the two second shaft bases 427 can be L-shaped and each of the two second shaft bases 427 includes a standing plate and bottom portion, the standing plate of each of the two second shaft bases 427 is sleeved on the second shaft body 421, and the bottom portion of each of the two second shaft bases 427 is fixed at the base 100 and integrally connected to the standing plate of each of the second two second shaft bases 427, so that the second shaft body 421 is loaded on the base 100 and is capable of rotating.

As shown in FIGS. 2 to 5, each of the two second linkage assemblies 430 can include at least one second swinging rod 433, a second lower pivot element 432 and a second waving rod 431. A first end of the aforementioned at least one second swinging rod 433 is pivotally connected to the second shaft assembly 420, the second lower pivot element 432 is disposed at the base 100, a first end of the second waving rod 431 is pivotally connected to a second end of the at least one second swinging rod 433, a second end of the second waving rod 431 is pivotally connected to the first shaft assembly 220 of the first actuating mechanism 200, and the second waving rod 431 is pivotally connected to the second lower pivot element 432 to swing about the second lower pivot element 432 that is served as a pivot point. In the present embodiment, a number of the second swinging rods 433 can be two, and the second waving rod 431 is sandwiched between the two second swinging rods 433. A structure of each of the second lower pivot elements 432 is similar with the structure of each of the first lower pivot elements 232, but, in the present embodiment, a height of each of the second lower pivot elements 432 is lower than a height of each of the first lower pivot elements 232. Each of connecting parts of the second waving rod 431 forms a bending shape, so that a displacement of the first shaft assembly 220 moved by the second waving rod 431 is substantially vertical to the base 100. In other embodiments, each of the connecting parts of the second waving rod can be configured in a configuration different from the configuration shown on the figures, and the present disclosure is not limited to the figures.

Furthermore, the difference between the two second linkage assemblies 430 and the two first linkage assemblies 230 is that the two second linkage assemblies 430 are connected to the two ends of the first shaft assembly 220 to move the whole first shaft assembly 220 vertically, the space usage of the two second linkage assemblies 430 is obviously smaller than the space usage of the two first linkage assemblies 230, and then a number of elements and the cost can be reduced. Therefore, in other embodiments, if single linkage assembly is connected to two ends of one shaft assembly and can move the whole shaft assembly vertically, the space usage thereof will be smaller so as to be capable of extending the functions of the vertical rhyme machine.

In other embodiments, the vertical rhyme machine can include a base, at least one first actuating mechanism, a top cover and a second actuating mechanism. The aforementioned at least one first actuating mechanism includes a first motor assembly, a first shaft assembly and two first waving rods. The first motor assembly is disposed at the base. The first shaft assembly is driven by the first motor assembly to rotate and includes a first shaft body and two first eccentric linking elements, the two first eccentric linking elements are connected to two ends of the first shaft body, respectively, and the two first waving rods are connected to the two first eccentric linking elements, respectively. The top cover is moved by the two first waving rods of the aforementioned at least one first actuating mechanism. The second actuating mechanism includes a second motor assembly, a second shaft assembly and two second linkage assemblies. The second motor assembly is disposed at the base. The second shaft assembly is driven by the second motor assembly to rotate and includes a second shaft body and two second eccentric linking elements. The second shaft body is disposed at the base, the two second eccentric linking elements are connected to two ends of the second shaft body, respectively, the two second linkage assemblies are connected to the two second eccentric linking elements, respectively, and the two second linkage assemblies are connected to the first shaft assembly of one of the aforementioned at least one first actuating mechanism. The first motor assembly of the aforementioned at least one first actuating mechanism drives the two first waving rods of the aforementioned at least one first actuating mechanism to move the top cover in an oscillation, the second motor assembly drives the two second linkage assemblies to move the first shaft assembly of the aforementioned one of the aforementioned at least one first actuating mechanism, so as to move the top cover in the oscillation by the two first waving rods of the aforementioned one of the aforementioned at least one first actuating mechanism. If a number of the first actuating mechanisms is two, there are two first motor assemblies. As an example in one side, a first one of the two first motor assemblies can drive a first one of the first waving rods at each side, a second one of the two first motor assemblies can drive a second one of the first waving rods at each side, and the second one of the first waving rods at each side is pivotally connected to the first one of the first waving rods at each side. The relation thereof can be similar with the relation of the second waving rod 431 pivotally connected to the first waving rod 231 in FIGS. 1 to 5, and then the second one of the first waving rods is pivotally connected to the top cover. Each of the two second motor assembly drives the two second linkage assemblies at each side, and the two second linkage assemblies at each side are pivotally connected to the first one of the first waving rods. Thus, when the two first motor assemblies and the second motor assembly are turned on individually or separately, the top cover can be moved in different oscillations. A complex wave oscillation can be formed by the combination of different oscillations, and the top cover can be moved in the oscillation with triangle wave, sawtooth wave, etc. to achieve the more various fitness results. Moreover, via the extension way shown above, the space usage thereof is small so as to be capable of extending the functions of the vertical rhyme machine.

Moreover, as shown in FIGS. 1 to 5, the vertical rhyme machine 10 can further include a plurality of buffer units 900, and each of the buffer units 900 is connected between the top cover 600 and the base 100. Specifically, the top cover 600 can include a plurality of pore portions 610, and each of the buffer units 900 can be substantially an elastic cylinder and penetrate through each of the pore portions 610 of the top cover 600. When the top cover 600 is moved reciprocatedly in the oscillation along an oscillating direction W and an oscillating direction M, the buffer units 900 can provide a buffering function to help the top cover 600 be moved stably in the oscillation.

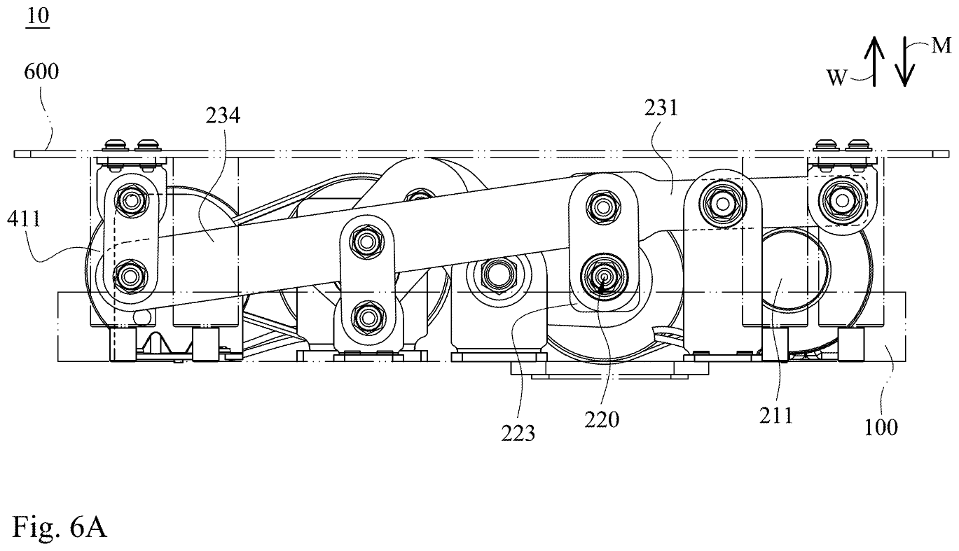

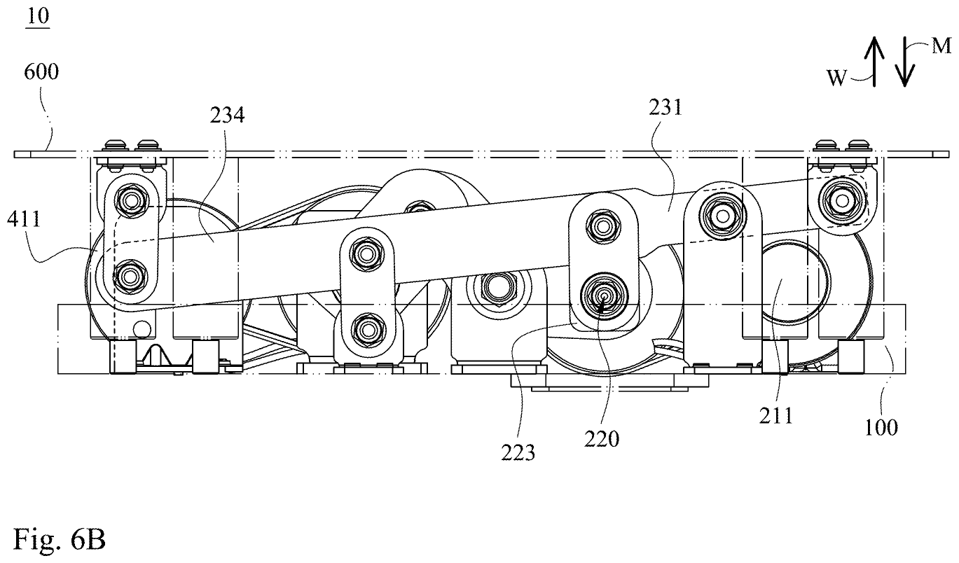

Please refer to FIGS. 6A and 6B, FIG. 6A shows a sided view of the vertical rhyme machine 10 when the top cover 600 is at the lowest point during swinging the first linkage assemblies 230 in a first oscillation state according to the embodiment in FIG. 1, and FIG. 6B shows a sided view of the vertical rhyme machine 10 when the top cover 600 is at the highest point during swinging the first linkage assemblies 230 in the first oscillation state according to the embodiment in FIG. 1. As shown in FIGS. 6A and 6B, in the first oscillation state, when the first motor 211 is turned on and the second motor 411 is turned off, the first shaft assembly 220 is substantially rotated without displacement. When each of the two first driving elements 223 is driven to substantially move towards the oscillating direction W, an end of each of the first waving rods 231 facing inwards and the first end of each of the first swinging rods 234 facing inwards move towards the oscillating direction W, so that the other end of each of the first waving rods 231 facing outwards and the second end of each of the first swinging rods 234 facing outwards move towards the oscillating direction M to move the top cover 600 towards the oscillating direction M; on the contrary, when each of the two first driving elements 223 is driven to substantially move towards the oscillating direction M, the end of each of the first waving rods 231 facing inwards and the first end of each of the first swinging rods 234 facing inwards move towards the oscillating direction M, so that the other end of each of the first waving rods 231 facing outwards and the second end of each of the first swinging rods 234 facing outwards move towards the oscillating direction W to move the top cover 600 towards the oscillating direction W.

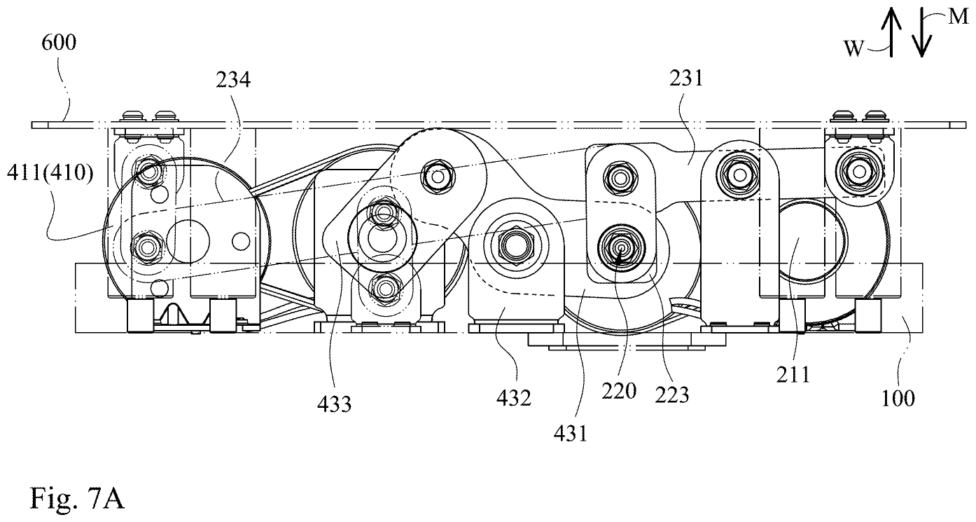

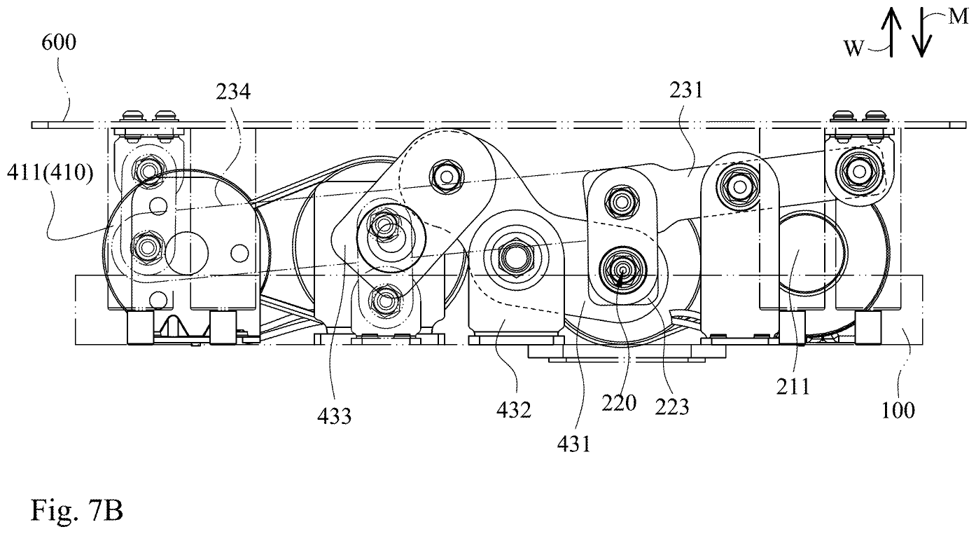

Please refer to FIGS. 7A and 7B, FIG. 7A shows a sided view of the vertical rhyme machine when the top cover is at the lowest point during swinging the second linkage assemblies 430 in a second oscillation state according to the embodiment in FIG. 1, and FIG. 7B shows a sided view of the vertical rhyme machine when the top cover is at the highest point during swinging the second linkage assemblies 430 in the second oscillation state according to the embodiment in FIG. 1. As shown in FIGS. 7A and 7B, in the second oscillation state, when the first motor 211 is turned off and the second motor 411 is turned on, the first shaft assembly 220 is moved by the two second linkage assemblies 430 to substantially move without rotation. At this moment, each of the two first driving elements 223 can be driven to be lifted or lowered, so that each of the first waving rods 231 and each of the first swinging rods 234 can be moved to swing in the same way shown in FIGS. 6A and 6B, and then the top cover 600 can be moved stably in the second oscillation. It is worthy to be noticed that there is difference between the second oscillation state and the first oscillation state. In the second oscillation state, the lowest point and the highest point of each of the two first driving elements 223 are affected by the sizes of the second motor assembly 410 and the two second linkage assemblies 430. In the first oscillation state shown in FIGS. 6A and 6B, the lowest point and the highest point of each of the two first driving elements 223 are affected by the sizes of the eccentric axial structure of the first shaft assembly 220. Hence, in the present embodiment, the sizes thereof can be configured to make the amplitude of the first oscillation be different from the amplitude of the second oscillation. Because the adjustability of each size of the second motor assembly 410 and the two second linkage assemblies 430 is higher than the adjustability of the size of the first shaft assembly 220, the sizes thereof can be configured to make the amplitude of the second oscillation be larger than the amplitude of the first oscillation, and then the range of the amplitude can be increased to achieve the more various fitness results. In the present embodiment, the amplitude of the first oscillation is about 2 mm, and the amplitude of the second oscillation is about 4 mm.

Moreover, in a third oscillation state, both of the first motor 211 and the second motor 411 are turned on, so each of the two first driving elements 223 is driven by the first motor 211 to be lifted or lowered in the range of 2 mm and driven by the second motor 411 to be lifted or lowered in the range of 4 mm to generate the third oscillation. An amplitude of the third oscillation is fluctuated by the phase difference between the first oscillation and the second oscillation in the range between 2 mm and 6 mm. That is, when the first motor 211 and the second motor 411 actuate at the same time, a various of amplitude difference can be generated.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A vertical rhyme machine, comprising:
a base;
a first actuating mechanism, comprising:
a first motor assembly disposed at the base;
a first shaft assembly driven by the first motor assembly to rotate, and comprising:
a first shaft body; and
two first eccentric linking elements connected to two ends of the first shaft body, respectively; and
two first linkage assemblies connected to the two first eccentric linking elements, respectively;
a top cover moved by the two first linkage assemblies; and
a second actuating mechanism, comprising:
a second motor assembly disposed at the base;
a second shaft assembly driven by the second motor assembly to rotate, and comprising:
a second shaft body disposed at the base; and
two second eccentric linking elements connected to two ends of the second shaft body, respectively; and
two second linkage assemblies connected to the two second eccentric linking elements, respectively, and the two second linkage assemblies connected to the first shaft assembly of the first actuating mechanism;
wherein, the first motor assembly drives the two first linkage assemblies to move the top cover in a first oscillation, the second motor assembly drives the two second linkage assemblies and the first shaft assembly is linked to move the two first linkage assemblies, so as to move the top cover in a second oscillation, and an amplitude of the first oscillation is different from an amplitude of the second oscillation.

2. The vertical rhyme machine of claim 1, wherein the first motor assembly comprises:
a first motor;
a first driving roller sleeved on the first shaft body; and
a first belt connecting the first driving roller to an output shaft of the first motor;
wherein the first motor drives the first belt to rotate the first shaft body.

3. The vertical rhyme machine of claim 1, wherein each of the two first linkage assemblies comprises:
a first lower pivot element disposed at the base;
a first upper pivot element disposed at the top cover; and
a first waving rod, wherein a first end of the first waving rod is pivotally connected to the first shaft assembly, a second end of the first waving rod is pivotally connected to the first upper pivot element, and the first waving rod is pivotally connected to the first lower pivot element to swing about the first lower pivot element that is served as a pivot point.

4. The vertical rhyme machine of claim 3, wherein each of the two first linkage assemblies further comprises:
a first bottom pivot element pivotally connected to the base;
a first top pivot element pivotally connected to the top cover; and
a first swinging rod, wherein a first end of the first swinging rod is pivotally connected to the first shaft assembly, a second end of the first swinging rod is pivotally connected to the first top pivot element, and the first swinging rod is pivotally connected to the first bottom pivot element to swing about the first bottom pivot element that is served as a pivot point.

5. The vertical rhyme machine of claim 1, wherein the second motor assembly comprises:
a second motor;
a second driving roller sleeved on the second shaft body; and
a second belt connecting the second driving roller to an output shaft of the second motor;
wherein the second motor drives the second belt to rotate the second shaft body.

6. The vertical rhyme machine of claim 1, wherein each of the two second linkage assemblies comprises:
at least one second swinging rod, wherein a first end of the at least one second swinging rod is pivotally connected to the second shaft assembly;
a second lower pivot element disposed at the base; and
a second waving rod, wherein a first end of the second waving rod is pivotally connected to a second end of the at least one second swinging rod, a second end of the second waving rod is pivotally connected to the first shaft assembly of the first actuating mechanism, and the second waving rod is pivotally connected to the second lower pivot element to swing about the second lower pivot element that is served as a pivot point.

7. The vertical rhyme machine of claim 1, wherein the amplitude of the second oscillation is larger than the amplitude of the first oscillation.

8. The vertical rhyme machine of claim 1, further comprising:
a plurality of buffer units, each of the buffer units is connected between the top cover and the base.

9. A vertical rhyme machine, comprising:
a base;
at least one first actuating mechanism, comprising:
a first motor assembly disposed at the base;
a first shaft assembly driven by the first motor assembly to rotate, and comprising:
a first shaft body; and
two first eccentric linking elements connected to two ends of the first shaft body, respectively;
two first waving rods connected to the two first eccentric linking elements, respectively;
a top cover moved by the two first waving rods of the at least one first actuating mechanism; and
a second actuating mechanism, comprising:
a second motor assembly disposed at the base;
a second shaft assembly driven by the second motor assembly to rotate, and comprising:
a second shaft body disposed at the base; and
two second eccentric linking elements connected to two ends of the second shaft body, respectively; and
two second linkage assemblies connected to the two second eccentric linking elements, respectively, and the two second linkage assemblies connected to the first shaft assembly of one of the at least one first actuating mechanism;
wherein, the first motor assembly of the at least one first actuating mechanism drives the two first waving rods of the at least one first actuating mechanism to move the top cover in an oscillation, the second motor assembly drives the two second linkage assemblies to move the first shaft assembly of the one of the at least one first actuating mechanism, so as to move the top cover in the oscillation by the two first waving rods of the one of the at least one first actuating mechanism.

10. The vertical rhyme machine of claim 9, wherein the first motor assembly of the at least one first actuating mechanism comprises:
a first motor;
a first driving roller sleeved on the first shaft body; and
motor;
a first belt connecting the first driving roller to an output shaft of the first motor;
wherein the first motor drives the first belt to rotate the first shaft body.

11. The vertical rhyme machine of claim 9, wherein the second motor assembly comprises:
a second motor;
a second driving roller sleeved on the second shaft body; and
a second belt connecting the second driving roller to an output shaft of the second motor;
wherein the second motor drives the second belt to rotate the second shaft body.

12. The vertical rhyme machine of claim 9, wherein each of the two second linkage assemblies comprises:
at least one second swinging rod, wherein a first end of the at least one second swinging rod is pivotally connected to the second shaft assembly;
a second lower pivot element disposed at the base; and
a second waving rod, wherein a first end of the second waving rod is pivotally connected to a second end of the at least one second swinging rod, a second end of the second waving rod is pivotally connected to the first shaft assembly of the first actuating mechanism, and the second waving rod is pivotally connected to the second lower pivot element to swing about the second lower pivot element that is served as a pivot point.

13. The vertical rhyme machine of claim 9, further comprising:
a plurality of buffer units, each of the buffer units is connected between the top cover and the base.
